(19) United States
(12) Patent Application Publication
(10) Pub. No.: US 2006/0279807 A1
(43) Pub. Date: Dec. 14, 2006

(54) Flat bed scanner

(76) Inventors: Chun-Hsiang Kung, Hsinchu (TW); Chou-Kan Peng, Hsinchu (TW); Chih-Ming Lin, Hsinchu (TW); Huan-Hsing Hsiao, Hsinchu (TW)

Correspondence Address: LIN & ASSOCIATES INTELLECTUAL PROPERTY, P.O. BOX 2339, SARATOGA, CA, 95070-0339, US

(21) Appl. No.: 11/148,100

(22) Filed: Jun. 8, 2005

(51) Int. Cl. H04N 1/04

(52) U.S. Cl. 358/494; 358/493

(57) ABSTRACT

A flat bed scanner having a transparent platform and a scanning mechanism is provided in the present invention. The transparent platform is used to support the objects that wait for scanning. The scanning mechanism is movably placed under the transparent platform along the length direction of the transparent platform. The scanning mechanism includes a plurality of LEDs, a camera lens and a CCD. The LEDs are arranged in a line along the width direction of the transparent platform. The scanning mechanism further includes a diffuser that is placed over the LEDs and has the same width with the transparent platform, and the diffuser diffuses the light beams radiated from the LEDs and then projects the light beams being diffused over the objects that wait for scanning.

### BACKGROUND OF THE INVENTION

1. Field of the Invention

The present invention relates to a flat bed scanner, especially to a flat bed scanner using Light Emitting Diodes (LEDs) as a light source.

2. The Related Art

Flat bed scanners are applied widely by people in their daily life and work. The flat bed scanners can quickly scan papers, photos or pictures to get the image information and further input the image information into a computer.

When scanning, the flat bed scanners project light beams radiated from light sources over the objects that wait for scanning. And then the objects further reflect the light beams over Charge Coupled Devices (CCDs). The CCDs convert the light signals into corresponding electrical signals in order to get the image information of the objects.

Conventional flat bed scanners generally use Cold Cathode Fluorescent Lamps (CCFLs) as light sources. In order to make the CCFLs radiate light beams, a step-up circuit is needed to bring a high voltage to the CCFLs. During the period for the step-up circuit to turn a low voltage into a high voltage, the step-up circuit will product high frequency signal that can interfere the Charge Coupled Devices (CCDs) and other electrical devices of the flat bed scanners to make the flat bed scanners work unstably. Furthermore, security problems can not be omitted, because the flat bed scanners are work under high voltages.

U.S. Pat. Publication No. 2004/0095620 discloses a flat bed scanner, which uses a Light Emitting Diode (LED) as a light source. The flat bed scanner further has a half-cylinder optical element. The LED is beside the half-cylinder optical element. A part of the light beam radiated from the LED is reflected/refracted from the top of the half-cylinder optical element and converged into a light strip over the objects that wait for scanning along the extending direction of the half-cylinder optical element.

Because the LED is beside the half-cylinder optical element, the light-intensity distribution of the light strip along the extending direction of the half-cylinder optical element is not evenly. Furthermore, because the light-intensity distribution of LED is also not evenly, the light-intensity distribution in the width becomes more uneven. Therefore, the image produced by the flat bed scanner has streaks.

### SUMMARY OF THE INVENTION

An object of the present invention is to provide a flat bed scanner that balances the light-intensity distribution of the light beam projected over the objects waiting for scanning, accordingly to enhance the quality of the image produced by the flat bed scanner.

To achieve the above object, the present invention provides a flat bed scanner comprises a transparent platform and a scanning mechanism. The transparent platform is used to support the objects that are waiting for scanning. The scanning mechanism is movably placed under of the transparent platform along the length direction of the transparent platform. The scanning mechanism includes a plurality of LEDs, a camera lens, a CCD and a diffuser. The LEDs are arranged in a line along the width direction of the transparent platform. The diffuser is set over the LEDs and has the same width with the transparent platform. The diffuser diffuses the light beams radiated from the LEDs and then projects the light beams being diffused over the objects that wait for scanning. The camera lens receives the light beams reflected from the objects, then the light beams being further projected over the CCD.

According to the flat bed scanner of the present invention, a plurality of LEDs are arranged in a line along the width direction of the transparent platform radiates light beams, and a diffuser diffuses the light beams to balance the light-intensity distribution of the light beams. Accordingly, the quality of the scanned image is enhanced.

### BRIEF DESCRIPTION OF THE DRAWINGS

FIG. 1 is a sketch diagram of a flat bed scanner according to the present invention.

FIG. 2 is a perspective view of the scanning mechanism of the flat bed scanner.

FIG. 3 is a partial perspective view of the scanning mechanism shown in FIG. 2.

FIG. 4 is a block diagram of the flat bed scanner.

FIG. 5 is a perspective view of another diffuser of the flat bed scanner.

### DETAILED DESCRIPTION OF THE PREFERRED EMBODIMENT

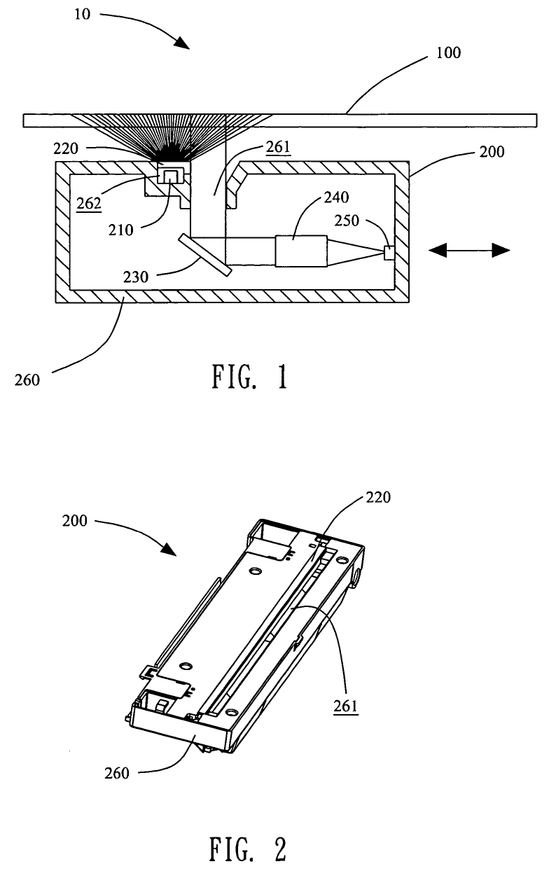

With reference to FIG. 1, a flat bed scanner 10 in accordance with the present invention comprises a transparent platform 100 and a scanning mechanism 200 which is placed under of the transparent platform 100.

The transparent platform 100 is made of a kind of high-transparent material for supporting objects which wait for scanning, such as papers, photos, and pictures.

The scanning mechanism 200 includes a plurality of Light Emitting Diodes (LEDs) 210, a transparent plastic slice 220, a camera lens 240, a plurality of Charge Coupled Devices (CCDs) 250 and a housing 260. Furthermore, the scanning mechanism 200 further has reflection devices 230 in order to reflect lights. An accommodating space is enclosed by the housing 260 to accommodate the reflection devices 230, the camera lens 240 and the CCDs 250.

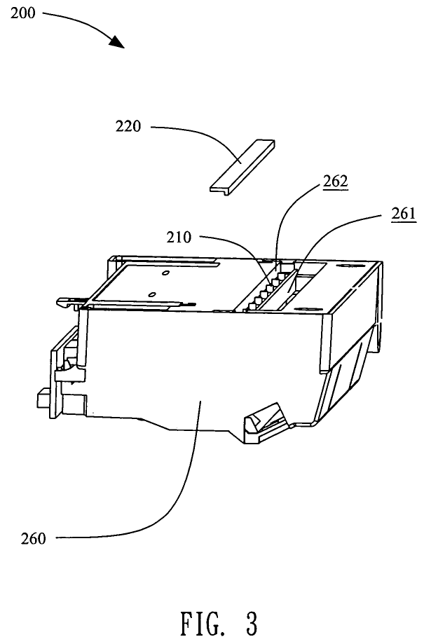

Please refer to FIG. 2 in conjunction with FIG. 3. There is a slot 261 with the same width with the transparent platform 100 set at the top of the housing 260 of the scanning mechanism 200. Near to the slot 261, a recess 262 is formed on the upper surface of the housing 260, which is parallel to the slot 261 and has the same width with the slot 261. The LEDs 210 are placed in the recess 262 and evenly arranged in a line along the width direction of the transparent platform 100. The cross section of the transparent plastic slice 220 is L-shaped. The transparent plastic slice 220 has the same width with the recess 262. The transparent plastic slice 220 is placed over the LEDs 210 and covers the recess 262. Accordingly, the LEDs 210 are enclosed in the recess 262.

When scanning, a light beam radiated from the LEDs 210 is projected to the transparent plastic slice 220. The light beam is diffused by the transparent plastic slice 220 in the direction of the length and width direction of the transparent platform 100, and then the light beam being diffused is projected over the objects that are waiting for scanning. Consequently, the light-intensity distribution in the scanning zone is balanced, so that the shortcoming that the light-intensity distribution is not even in the prior art is overcome. The light beam is further reflected over the reflection devices 230 from the objects that are waiting for scanning. And then the light beam is further reflected to the camera lens 240, and further to the CCDs 250. Finally, the CCDs 250 convert the light signal into the corresponding electrical signal.

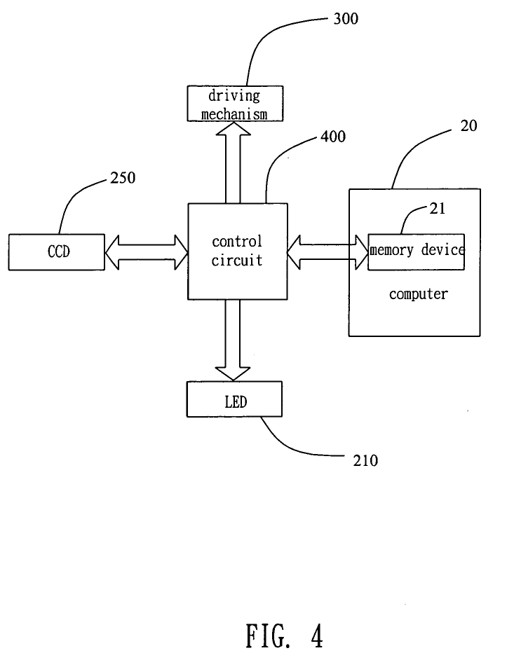

In order to get the full image information of the objects that wait for scanning, the flat bed scanner 10 of the present invention further includes a driving mechanism 300 and a control circuit 400 (shown in FIG. 4). The LEDs 210 are controlled by the control circuit 400 to radiate light beams. The driving mechanism 300 is controlled by the control circuit 400 to make the scanning mechanism 200 to move along the length direction of the transparent platform 100 (shown in FIG. 1). Accordingly, the full image information of the objects that wait for scanning is achieved. The control circuit 400 still controls the CCDs 250 to get the image information and further input the image information into a memory device 21 of an outer computer 20.

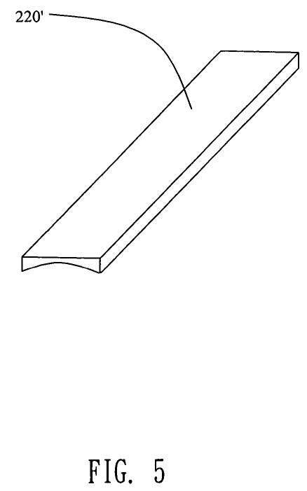

According to the present invention, the transparent plastic slice 220 of the flat bed scanner 10 is used to diff-use light beams, so that other diffusers can be used to replace the transparent plastic slice 220. For example, a strip-shaped concave lens 220′ can be used to replace the transparent plastic slice 220 as shown in FIG. 5.

As the above mentioned, by the LEDs 210 arranged in a line along the width direction of the transparent platform 100 and a diffuser such as the transparent plastic slice 220 or the strip-shaped concave lens 220′ diffusing the light beams radiated from the LEDs 210, the light-intensity distribution of the light beam projected in the scanning zone is balanced, accordingly, the quality of the scanned image is enhanced.

It will be understood that certain features and subcombinations are of utility and may be employed without reference to other features and subcombinations as they are outlined within the description above and within the claims appended hereto. While the preferred embodiment and application of the invention have been described, it is apparent to those skilled in the art that the objects and features of the present invention are only limited as set forth in the claims appended hereto.

What is claimed is:

1. A flat bed scanner, comprising:
a transparent platform used to support the objects that are waiting for scanning;
a scanning mechanism movably placed under of the transparent platform along the length direction of the transparent platform, said scanning mechanism including a plurality of LEDs, a camera lens and a CCD, said camera lens receiving the light beams reflected from the objects, then the light beams being further projected over the CCD;
wherein the LEDs are arranged in a line along the width direction of the transparent platform, the scanning mechanism further includes a diffuser that is set over the LEDs and has the same width with said transparent platform, and the diffuser diffuses the light beams radiated from the LEDs and then projects the light beams being diffused over the objects that wait for scanning.

2. The flat bed scanner as claimed in claim 1, wherein said diffuser is a transparent slice.

3. The flat bed scanner as claimed in claim 2, wherein the cross section of said transparent slice is L-shaped.

4. The flat bed scanner as claimed in claim 2, wherein the transparent slice is made of plastic.

5. The flat bed scanner as claimed in claim 1, wherein said diffuser is a strip-shaped concave lens.

6. The flat bed scanner as claimed in claim 1, wherein said scanning mechanism further has at least one reflection device to reflect and project the light beams from the objects that wait for scanning over the camera lens.
